(19) United States
(12) Patent Application Publication
(10) Pub. No.: US 2002/0168890 A1
(43) Pub. Date: Nov. 14, 2002

(54) Light plug with storage compartment

(76) Inventor: W. Richard Frederick, Mundelein, IL (US)

Correspondence Address: Stephen G. Rudisill, JENKENS & GILCHRIST, 225 W. Washington Street, Suite 2600, Chicago, IL, 60606, US

(21) Appl. No.: 09/854,255

(22) Filed: May 14, 2001

(51) Int. Cl. H01R 13/72

(52) U.S. Cl. 439/501

(57) ABSTRACT

An electrical plug or receptacle with a compartment for storing spare electrical components such as fuses and bulbs. The plug is molded with the walls of the compartment integrally formed with the plug. A cover is adapted to cover the open top. The cover can be latched to securely retain the spare components within the compartment. An opening can be provided in one of the walls to function as a lamp removal tool. In an alternative embodiment the compartment is molded separately from the plug or receptacle and is adapted for mounting to the plug or receptacle.

### BACKGROUND AND SUMMARY OF THE INVENTION

This invention relates to electrical plugs and receptacles and more particularly to a storage compartment formed with the plug or receptacle.

Many electrical devices are supplied with a multitude of replacement components. This is especially true of strings of Christmas Lights. These light strings are generally comprises of approximately one hundred lamps wired in series. The lamps vary in size, voltage and color. One manufacturer's lamps are not necessarily interchangeable with another manufacturer's lamps. Furthermore the lamp voltages, bases and sockets are not necessarily the same from manufacturer to manufacturer. The fuses used to protect each string of lamps are also not necessarily interchangeable from string to string as the amperage of each string may vary from manufacturer to manufacturer. For example the one ampere fuse from a fifty light string and the three ampere fuse from a one hundred light string are not interchangeable.

Christmas Lights are commonly purchased a few strings at a time. At the time of original purchase, each string of Christmas Lights is normally supplied with spare lamps, flashers and spare fuses. These are selected to match the original string of lamps so that the user has the proper replacement parts. Having and using the proper replacement parts is not only a convenience, it is a matter of safety. It is common that the replacement parts are placed in a plastic bag that is packed with the string of lights. The bag may be left loose in the package or may be stapled or taped to the light string. Each manufacturer has its own set of spare fuses and lamps resulting in the user collecting numerous bags of spare parts. Generally the user takes the spare parts bag and puts it away. The bag is often lost, misplaced or otherwise can't be located when the parts are needed. If the user finds the place where the numerous bags of spare parts are kept, the user usually cannot identify which bag of spare parts is used for a given string of lights.

Some people merely throw the entire string of lights away if a bulb burns out. This is expensive, wasteful and is inconvenient to keep replacing an entire light string when one lamp burns out. Leaving the burned lamp in its socket increases the voltage to other lamps in the string resulting in shortening the life of the other lamps and exasperates the problem.

The manufacturer may also supply special tools or items such as a bulb remover designed for use with the Christmas Lights. The problem with this is the same as the replacement bulbs; the tool can be easily lost. Another problem is that these special bulb removing tools are always sold separately and have not been provided with the light set in the current marketplace.

Applicant's invention solves the problem of losing or misplacing the spare parts provided with a string of Christmas Lights. A storage compartment is provided as an integral part of the electrical plug. It can be molded as a part of the plug or can be an add-on compartment for existing plugs. The compartment can be opened from the top, side or surface end to allow access to the interior of the compartment. The compartment is designed to accommodate the extra lamps and fuses normally supplied in a plastic bag. The compartment can also access the easy-to-store bulb remover, or it can have the bulb remover formed as a part of the compartment.

Thus it is an object of the present invention to provide an electrical plug that has integrally formed therein a storage compartment for spare components. It is a related object to provide an electrical plug or receptacle with a storage compartment for spare lamps and fuses to be used in a Christmas Light string.

It is another object to provide a storage compartment for spare electrical components that can be easily mounted onto an electrical plug or receptacle.

Another object is to provide an electrical plug with a storage compartment in which the storage compartment has watertight sealing means to seal the door opening, thus keep the stored spare components dry.

Still another object is to provide an electrical plug or receptacle with a storage compartment in which the storage compartment has integrally formed therein a lamp-removing tool. The advantage of this is that it eliminates the need for a separate tool that may be easily lost.

Another object is to provide an electrical plug or receptacle with an integrally formed storage compartment that is economical to make and costs substantially the same as conventional methods to commercially implement.

Yet another object is to have readily available the proper replacement fuse to minimize the possibility of the user selecting and using an improperly sized fuse which creates a safety hazard.

These and other objects and advantages will be apparent to those skilled in the art upon reading the Description of the Drawings and Description of the Preferred Embodiment.

### DESCRIPTION OF THE DRAWINGS

FIG. 1 is a perspective view of the inventive electrical plug with an integrally molded storage compartment.

FIG. 2 is a top view of the electrical plug of FIG. 1.

FIG. 3 as a left end view of the plug of FIG. 1.

FIG. 4 is a side elevation view of the inventive electrical plug of FIG. 1.

FIG. 5 is a left end view of a first alternative embodiment of the inventive electrical plug in which a semi-circular lamp remover is formed in the body of the plug.

FIG. 6 is a left end view of a second alternative embodiment of the inventive plug in which the body of the plug and the cover form a circular lamp remover.

FIG. 7 is a left end view of a third alternative embodiment of the inventive plug in which the cover is slidably retained in channels on the body of the plug.

FIG. 8 is a side elevation view of a fourth alternative embodiment of the inventive plug in which the compartment is a separate component that is attached to a conventional electrical plug.

FIG. 9 is a side elevation view of another alternative embodiment in which the compartment is attached to a receptacle instead of a plug.

### DESCRIPTION OF THE PREFERRED EMBODIMENT

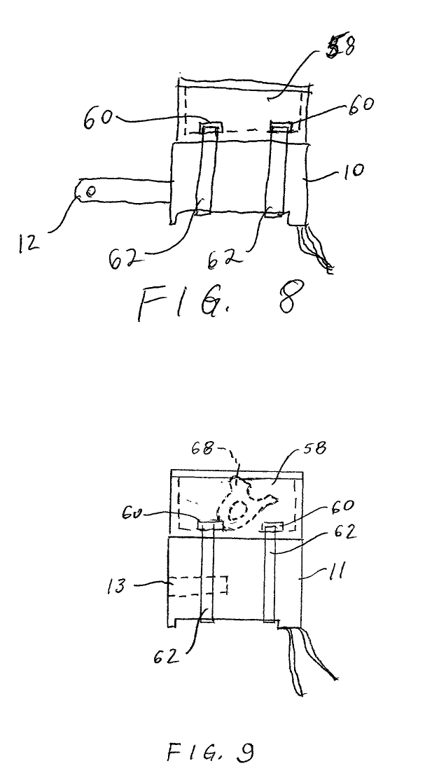

Turning to FIG. 1 there is illustrated an electrical plug 10 of the present invention. The electrical plug 10 is molded of an electrically non-conductive material such as plastic or a rubber compound. There are electrical prongs 12 that engage a socket. Alternatively the inventive electrical plug can be formed as a receptacle 11 (FIG. 9) on the female end or socket end of an electrical cord. There are two or more commonly three electrical wires 14 that connect to the prongs 12 or, in the case of a female plug, to the receptacles in the socket. Throughout this application the term “electrical plug” shall also mean an “electrical socket”. The electrical wires 14 have a plurality of electrical sockets 16 connected to them. In the case of Christmas Lights, the electrical connection is generally a series connection. Each socket 16 has a lamp 18 mounted in it. There may be thirty-five to one hundred fifty lights in a string of Christmas Lights. The lamps are commonly 2.5 or 3.5 volts each and may be made of various colors for decoration.

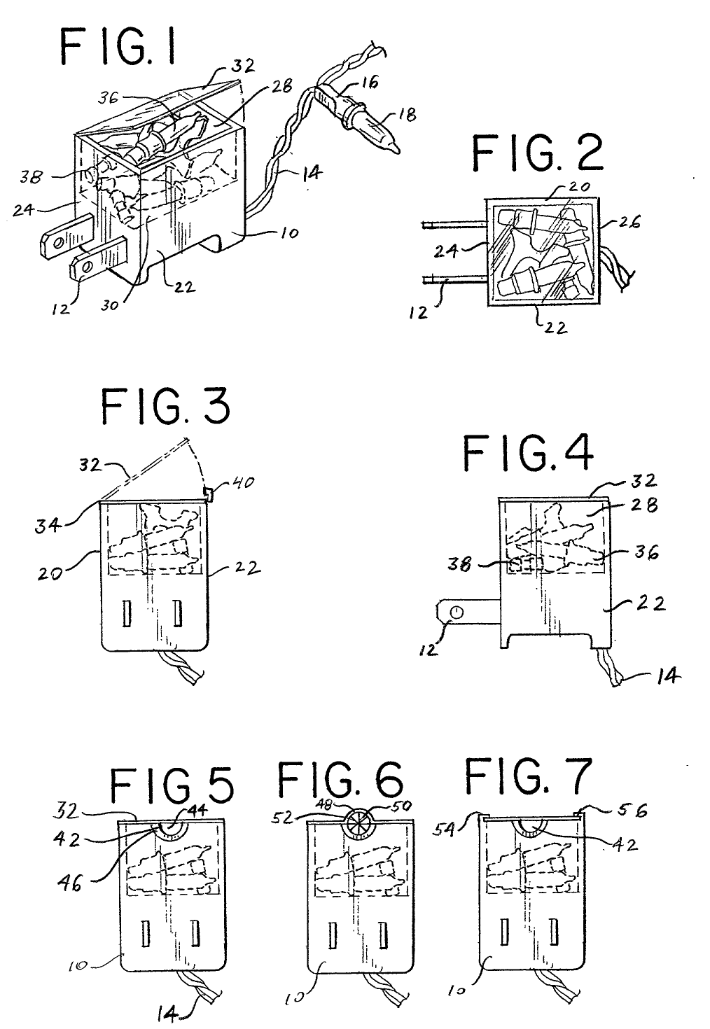

As seen in FIGS. 1 and 2, the molded plug 10 has a pair of opposed sidewalls 20, 22, a front wall 24 and a rear wall 26. Alternatively the molded plug may be formed of other configurations such as a dome, cylinder or circle. Within the confines of the walls 20-26 is a compartment 28. The compartment 28 has a bottom 30. There is a cover 32 that closes the top of the compartment 28. The cover 32 is attached to the sidewall 20 by means of a molded or living hinge 34. The living hinge 34 can be formed at the same time that the electrical plug 10 is molded. This minimizes the cost and number of components necessary to attach the cover 32 to the sidewall 20. The cover 32 can be made of clear plastic or colored plastic or rubber, depending on the needs and desires of the manufacturer and user. The compartment is dimensioned to hold several spare lamps 36, spare fuses 38 and a bulb pulling tool. The cover 32 can also be provided with a set of raised domes or bubbles that are used to indicate light bulb voltage, amperage or other information relating to the bulbs or fuses. By depressing the appropriate domes or bubbles, the user has a visual indication of the bulbs or fuses to buy for replacement items. Additional information such as the number of lights in a string, the length of the string, the date purchased or other such indications can also be added to the cover by similar indicia. Alternatively, the voltage, amperage or other important information can be molded into the plug 10, the cover 32 or bottom 30 when the parts are formed. This is a safety feature so that the user always knows what size lamps and fuses he or she should be using with a string of lights.

In order to keep the cover 32 in a secure closed position on the compartment 28 there is provided a latch means 40 on the top of the side wall 22. The latch can be a molded piece of rubber that engages an edge of the cover 32 opposite the living hinge. Instead of a latch, a magnetic strip may be added to the top of the sidewall 22 and a complementary magnetic strip on the edge of the cover 32. Other closure devices could be utilized as known in the art. It is preferable that the cover be water tight to keep moisture from entering the compartment 28 and possibly damaging the spare lamps 36 or fuses 38.

As described above, there is provided a compartment 28 that is capable of storing spare lamps 36 and spare fuses 38 that is integral with the molded electrical plug 10. The spare components are readily accessible when needed. The user merely opens the cover 28, removes the needed spare, and closes the cover. There is no searching for the whereabouts of the spare parts bag or worrying about installing a wrong lamp or fuse. The current system of supplying the spare parts in a bag that is stapled to the wires between tow of the bulbs also presents another safety issue. The staple can pierce the insulation and wire or can scratch the wire or the person removing the staple.

In FIG. 5, there is an alternative embodiment in which a semi-circular recess 42 is formed in the front wall 24. The semi-circular recess 42 forms an opening 44 that creates a lamp remover tool to remove burned out lamps from their respective sockets. The diameter of the opening 44 is substantially the same as the diameter of the base of the lamp 18. This allows the base of a burned out lamp 18 to be inserted into the opening 44 when the cover is opened. The cover is closed and held down by the user. This securely holds the lamp in the opening 44. The user then pulls the socket 16 away from the lamp 18. Optionally the recess 42 may have a metal insert 46 placed around its edge if the material forming the front wall 24 is not strong enough to withstand the force necessary to remove the burned out lamp. The recess is illustrated in the front wall 24 but can also be formed in the rear wall 26. A small piece of flexible material can also be formed on the cover or as part of the front wall 24 to partially or completely cover the opening 44. This keeps the spare lamps of fuses from falling out through the opening 44.

FIG. 6 illustrates another alternative embodiment. The cover 28 is formed with a semi-circular dome 48 that aligns with the semi-circular recess 42 in the front wall 24. The aligned dome 48 and recess 42 forms a circular opening 50. The dimension should be slightly smaller than the diameter of the socket 16. When a burned out lamp 18 is inserted into the opening 50, the user holds the socket 16 in place. The lamp 18 is then pulled out from the socket 16. There is optionally provided a flexible webbed material 52 that has a plurality slits emanating from the center of the opening 50 toward the circumference of the opening 50. This provides a covered opening that is easily penetrated by a lamp 18 when it is inserted into the opening 50. The webbed material 52 can be easily formed with the cover 32 and front wall 24.

FIG. 7 illustrates another alternative embodiment in which the cover 32 is attached to the molded plug 1 0 by a different means. Instead of using a molded hinge 34, the cover 32 is held within a pair of u-shaped channels 54, 56 extending along the top of the sidewalls 20, 22. The u-shaped channels 54, 56 retain the edges of the cover 32 so that the cover can be removed from the compartment 28 by sliding the cover 32 horizontally along the top of the compartment 28. The same types of lamp removers as described in the alternative embodiments shown in FIGS. 5 and 6 can be used with the embodiment described in FIG. 7.

FIG. 8 illustrates another alternative embodiment in which a compartment 58 is formed as a separate stand-alone element. The compartment 58 can have the same features as the previously described compartment 28 such as different closure means and alternative lamp removal devices. However the compartment 58 has one or more open slots 60 at its bottom. The slots 60 receive a plastic closure device such as conventionally used to secure bundles of wires together. These wire ties securely hold the compartment 58 to the molded electrical plug 10. Other means such as clips or clamps can be used to attach the compartment 58 to the plug 10. Such alternative fastening means will be apparent to those skilled in the art. In this manner the compartments 58 can be added to existing Christmas Light strings.

FIG. 9 illustrates another alternative embodiment in which the plug 10 is replaced by a receptacle 11 having electrically conductive socket receiving slots 13 to receive the electrical prongs 12. The compartment 58 is otherwise the same as described in FIG. 8 above. The compartment 58 is shown holding a bulb puller or bulb removing tool 68. Any of the plugs 10 described herein can be replaced by a receptacle 11 with all other features of the compartment remaining intact.

Thus there has been described an electrical plug that has a storage compartment for safely and securely storing spare lamps and fuses. Furthermore the storage compartment provides an integrally formed lamp remover. The invention has been described in conjunction with a specific embodiment and several alternatives; it is evident that other alternatives, modifications and variations will be apparent to those skilled in the art in light of the foregoing description. Accordingly it is intended to embrace all such alternatives, modifications and variations as fall within the spirit and scope of the appended claims.

What is claimed is:

1. An electrical plug or receptacle comprising:
a molded plug base;
at least two electrical conductors retained in the molded plug base;
at least two electrical wires, one of said wires connected to one of the electrical conductors and the other of said wires connected to the other electrical connector;
a compartment integrally formed with the molded plug base, the compartment defined by perimeter walls and a bottom, and having an open top;
a cover over the open top; and
means for mounting the cover to the compartment to allow the open top to be selectively opened and closed.

2. The electrical plug or receptacle of claim 1 and further comprising hinge means for connecting the cover to the compartment for allowing the cover to pivot about the hinge means to selectively open and close the open top.

3. The electrical plug or receptacle of claim 2 and further comprising locking means for selectively maintaining the cover in a closed position until the cover is to be opened.

4. The electrical plug or receptacle of claim 1 and further comprising opposite channels on the compartment, the channels adapted to slidably receive the cover, whereby the cover can be selectively slid in the channels to open and close the open top.

5. The electrical plug or receptacle of claim 1 and further comprising an opening in the compartment, the opening adapted to receive in frictional engagement a base of an electrical lamp, to assist in removing the electrical lamp from its socket.

6. The electrical plug or receptacle of claim 5 and further comprising a domed portion on the cover, the domed portion defining a second opening, the second opening aligned with the opening to receive the base of the electrical lamp in frictional engagement to assist in removing the electrical lamp from its socket.

7. The electrical plug or receptacle of claim 5 and further comprising closure means to cover the opening when no bulb is placed therein for removal.

8. The electrical plug or receptacle of claim 7 wherein the closure means comprise a closure member mounted on the cover that covers the opening when the cover is in its closed position over the open top.

9. The electrical plug or receptacle of claim 6 and further comprising closure means to cover both the opening and the second opening when no bulb is placed therein for removal.

10. The electrical plug or receptacle of claim 1 wherein the compartment is defined by at least four walls, a front wall, a rear wall opposite the front wall, and opposite sidewalls.

11. The electrical plug of claim 1 wherein the cover has means for selectively indicating a technical specification of the bulbs.

12. A compartment for mounting on an electrical plug or receptacle comprising:
a plurality of interconnected walls, a bottom and an open top,
a cover over the open top;
means for mounting the cover to the compartment to allow the open top to be selectively opened and closed; and
fastening means for attaching the compartment to the electrical plug or receptacle.

13. The compartment of claim 12 and further comprising hinge means for connecting the cover to any one of the plurality of interconnected walls to allow the cover to pivot about the hinge means to selectively open and close the open top.

14. The compartment of claim 13 and further comprising locking means for selectively maintaining the cover in a closed position until the cover is to be opened.

15. The compartment of claim 12 and further comprising at least two opposite interconnected walls, and channels on the two opposite interconnected walls, the channels adapted to slidably receive the cover, whereby the cover can be selectively slid in the channels to open and close the open top.

16. The compartment of claim 12 and further comprising an opening in one of the interconnected walls, the opening adapted to receive in frictional engagement a base of an electrical lamp, to assist in removing the electrical lamp from its socket.

17. The compartment of claim 16 and further comprising a domed portion on the cover, the domed portion defining a second opening, the second opening aligned with the opening to receive the base of the electrical lamp in frictional engagement to assist in removing the electrical lamp from its socket.

18. The compartment of claim 16 and further comprising closure means to cover the opening when no bulb is placed therein for removal.

19. The compartment of claim 18 wherein the closure means comprise a closure member mounted on the cover that covers the opening when the cover is in its closed position over the open top.

20. The compartment of claim 17 and further comprising closure means to cover both the opening and the second opening when no bulb is placed therein for removal.

21. An electrical plug or receptacle comprising:
a plug base;
a pair of electrical conductors retained in the plug base;
a pair of electrical wires, one wire of the pair connected to one of the electrical conductors and the other wire of the pair connected to the other electrical connector;
a compartment integrally formed with the plug base, the compartment having walls, a bottom, and an open top;
a cover hingedly connected to one of the walls is to selectively open and close the open top; and
means for releasably latching the cover in a closed position on the open top.

22. The electrical plug of claim 21 and further comprising an opening in one of the walls for receiving a base of an electrical lamp for removing the lamp from an electric socket.
